(19) United States
(12) Patent Application Publication
(10) Pub. No.: US 2004/0223433 A1
(43) Pub. Date: Nov. 11, 2004

(54) Optical disc playback apparatus, microcomputer, and rotational speed control method for optical disc playback apparatus

(75) Inventors: Osamu Yamada, Gunma (JP); Hiroyuki Shiono, Gunma (JP)

Correspondence Address: SOCAL IP LAW GROUP, 310 N. WESTLAKE BLVD. STE 120, WESTLAKE VILLAGE, CA, 91362, US

(73) Assignee: Sanyo Electric Co, Ltd., Osaka (JP)

(21) Appl. No.: 10/820,683

(22) Filed: Apr. 7, 2004

(30) Foreign Application Priority Data
Apr. 7, 2003 (JP) 2003-103290

(51) Int. Cl. G11B 7/00

(52) U.S. Cl. 369/47.44; 369/53.34; 369/53.35; 369/47.45

(57) ABSTRACT

An optical disc playback apparatus which makes an optical disc rotate at given rotational speed and reproduces a record signal based on light reflected from the optical disc. The optical disc playback apparatus comprises a jitter amount detector that detects a jitter amount based on a signal obtained from the reflected light, and a rotational speed adjustment circuit that adjusts the rotational speed of the optical disc based on the jitter amount.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### RELATED APPLICATION INFORMATION

The present application claims priority upon Japanese Patent Application No. 2003-103290 filed on Apr. 7, 2003, which is herein incorporated by reference.

### BACKGROUND OF THE INVENTION

1. Field of the Invention

The present invention relates to an optical disc playback apparatus, a microcomputer, and a rotational speed control method for the optical disc playback apparatus.

2. Description of Related Art

Optical disc apparatuses make an optical disc rotate at a predetermined linear velocity (rotational speed) determined based on a standard corresponding to the type of optical disc, and reproduce a signal recorded thereon. Refer to, for example, Japanese Patent Application Laid-open Publication No. 2000-293855.

That is, as shown in FIG. 1, in a playback apparatus for an optical disc 1, when receiving a command signal CS from a microcomputer 8, a DSP 4 outputs control signals (focus balance signal FBAL, tracking balance signal TBAL, and motor control signal MTR) to a driver 5. Based on these control signals FBAL, TBAL, MTR, the driver 5 drives an optical pickup 2 and a spindle motor 10. As a result, the optical disc 1 rotates at given rotational speed, and in addition, the optical pickup 2 moves to the lead-in area of the optical disc 1. The optical pickup 2 irradiates the optical disc 1 with laser light and receives the reflected light to read out an RF signal (obtained from the reflected light). An RF amplifier 3 amplifies the RF signal read out by the optical pickup 2 and outputs the amplified signal to the DSP 4. According to the read-out RF signal, a servo circuit 9 of the DSP 4 generates the control signals so as to make the optical pickup 2 focus on the pit surface of the optical disc 1, and thereby establishes focusing servo and tracking servo.

However, when trying to play a low-quality optical disc whose pit accuracy is below a predetermined standard or a badly-made optical disc having disturbances such as scratches on its signal recording surface, a problem occurs. That is, when trying to play a low-quality or badly-made optical disc, the RF signal does not become sufficient in level because reflected light having enough intensity cannot be obtained. Thus, there is the problem that an error rate amount increases and playability is greatly reduced.

### SUMMARY OF THE INVENTION

An optical disc playback apparatus according to one aspect of the present invention, which makes an optical disc rotate at given rotational speed and reproduces a record signal based on light reflected from the optical disc, comprises a jitter amount detector that detects a jitter amount based on a signal obtained from the reflected light; and a rotational speed adjustment circuit that adjusts the rotational speed of the optical disc based on the jitter amount.

The rotational speed of the optical disc is adjusted based on the jitter amount. Thus, the rotational speed of the optical disc can be appropriately adjusted so as to enable good reproduction. Moreover, the adjustment of rotational speed of the optical disc can be instantaneously performed based on the instantaneous jitter amount.

Furthermore, the rotational speed adjustment circuit can be configured to perform the adjusting of the rotational speed prior to the reproducing from the optical disc.

Therefore, it can be determined whether the optical disc is so badly made that it cannot be played at high rotational speed, at a stage before playback. Thus, an excess speed-adjustment operation after the start of playback can be reduced. That is, when an optical disc cannot be played at high rotational speed, the optical disc is played at standard speed defined in the standard for the optical disc without the need for rotational speed adjustment during playback.

Yet further, the rotational speed adjustment circuit can be configured to adjust the rotational speed to be multiplied speed when the jitter amount is equal or less than a threshold value.

Here, the term “multiplied speed” refers to high speed that is the result of multiplying a positive, greater than one number of times the standard speed defined in the standard for an optical disc such as DVD, the number including not only integers but also real numbers other than integers such as 1.5 and 2.5.

By adjusting the rotational speed of the optical disc to be multiplied speed, the high-speed rotation of the optical disc is possible. Thus, even if disturbances such as scratches exist on the optical disc, time during which the disturbances affect the reproduction in playback can be shortened due to the high-speed rotation of the optical disc. Therefore, in playback, the influence of disturbances such as scratches on the servo system can be reduced, and thereby playability can be improved.

An optical disc playback apparatus according to another aspect of the present invention, which makes an optical disc rotate at given rotational speed and reproduces a record signal based on light reflected from the optical disc, comprises an error rate amount detector that detects an error rate amount based on a signal obtained from the reflected light; and a rotational speed adjustment circuit that adjusts the rotational speed of the optical disc based on the error rate amount.

The rotational speed of the optical disc is adjusted based on the error rate amount. Thus, the rotational speed of the optical disc can be appropriately adjusted so as to enable good reproduction.

Moreover, the rotational speed adjustment circuit can be configured to perform the adjusting of the rotational speed during the reproducing from the optical disc.

Therefore, during playback, the error rate amount is detected, and the rotational speed of the optical disc can be adjusted. Thus, the rotational speed can be adjusted to become an optimum speed according to the error rate amount as needed. In particular, corresponding to scratches and the like in each region such as the inner region and outer region of the optical disc, the rotational speed of the optical disc can be adjusted as needed.

Yet further, the rotational speed adjustment circuit can be configured to adjust the rotational speed to be multiplied speed when the error rate amount is equal or less than a threshold value.

Therefore, by adjusting the rotational speed of the optical disc to be multiplied speed, the high-speed rotation of the optical disc is possible. Thus, even if disturbances such as scratches exist on the optical disc, time during which the disturbances affect the reproduction in playback can be shortened due to the high-speed rotation of the optical disc. Therefore, in playback, the influence of disturbances such as scratches on the servo system can be reduced, and thereby playability can be improved.

An optical disc playback apparatus according to further aspect of the present invention, which makes an optical disc rotate at given rotational speed and reproduces a record signal based on light reflected from the optical disc, comprises a jitter amount detector that detects a jitter amount based on a signal obtained from the reflected light; a first rotational speed adjustment circuit that adjusts the rotational speed of the optical disc based on the jitter amount; an error rate amount detector that detects an error rate amount based on a signal obtained from the reflected light; and a second rotational speed adjustment circuit that adjusts the rotational speed of the optical disc based on the error rate amount.

Therefore, the rotational speed of the optical disc is adjusted based on the error rate amount and the jitter amount. Thus, the rotational speed of the optical disc can be appropriately adjusted so as to enable good reproduction. Moreover, the adjustment of rotational speed of the optical disc can be instantaneously performed based on the instantaneous jitter amount.

A microcomputer according to the present invention, which is used in the optical disc playback apparatuses, functions at least as the rotational speed adjustment circuit.

A rotational speed control method according to one aspect of the present invention for an optical disc playback apparatus, which makes an optical disc rotate at given rotational speed and reproduces a record signal based on light reflected from the optical disc, comprises the steps of detecting a jitter amount based on a signal obtained from the reflected light; and adjusting the rotational speed of the optical disc based on the jitter amount.

A rotational speed control method according to another aspect of the present invention for an optical disc playback apparatus, which makes an optical disc rotate at given rotational speed and reproduces a record signal based on light reflected from the optical disc, comprises the steps of detecting an error rate amount based on a signal obtained from the reflected light; and adjusting the rotational speed of the optical disc based on the error rate amount.

A rotational speed control method according to further aspect of the present invention for an optical disc playback apparatus, which makes an optical disc rotate at given rotational speed and reproduces a record signal based on light reflected from the optical disc, comprises the steps of detecting a jitter amount based on a signal obtained from the reflected light; adjusting the rotational speed of the optical disc based on the jitter amount; detecting an error rate amount based on a signal obtained from the reflected light; and adjusting the rotational speed of the optical disc based on the error rate amount.

Features and objects of the present invention other than the above will become clear by reading the description of the present specification with reference to the accompanying drawings.

### DESCRIPTION OF THE DRAWINGS

For a more complete understanding of the present invention and the advantages thereof, reference is now made to the following description taken in conjunction with the accompanying drawings wherein:

FIG. 1 is a block diagram of an optical disc playback apparatus according to one embodiment of the present invention;

FIG. 2 is a block diagram of the main part of the optical disc playback apparatus according to the embodiment of the present invention; and

FIG. 3 is a flow chart showing the operation of adjusting the rotational speed of an optical disc by the optical disc playback apparatus according to the embodiment of the invention.

### DETAILED DESCRIPTION OF THE INVENTION

At least the following matters will be made clear by the explanation in the present specification and the description and the description of the accompanying drawings.

Basic Configuration and Operation

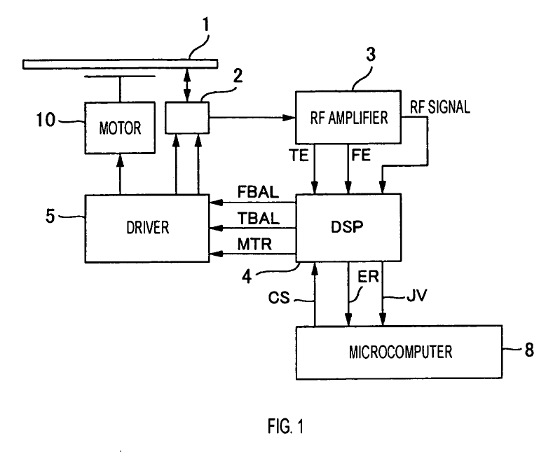

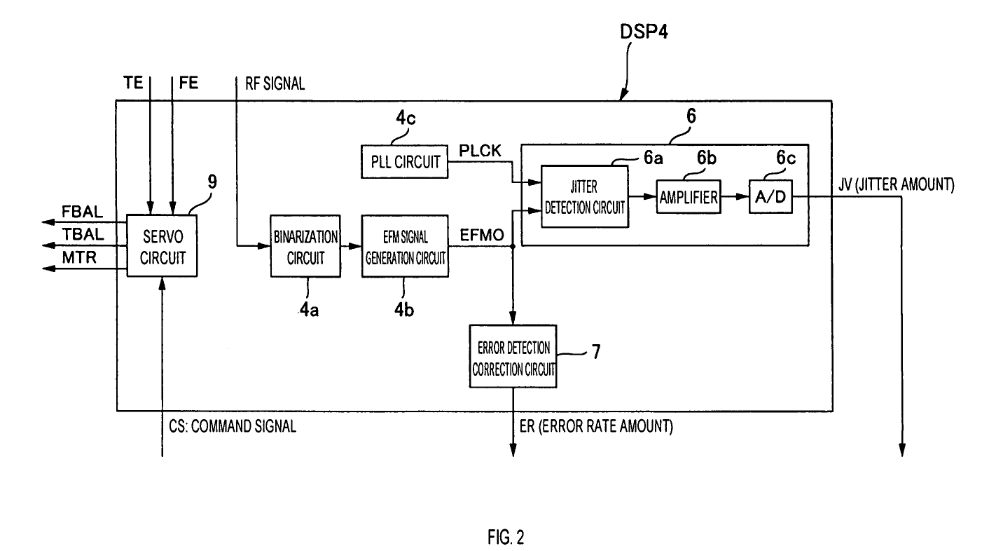

The configuration of an optical disc playback (and/or recording) apparatus that reproduces a record signal based on reflected light from an optical disc, according to the present embodiment will be described with reference to the block diagrams of FIGS. 1 and 2.

As shown in FIG. 1, the basic configuration of the playback apparatus for an optical disc 1, as well known, includes an optical pickup 2, an RF amplifier 3, a digital signal processor (hereinafter, called DSP) 4, a driver 5, a microcomputer (rotational speed adjustment circuit) 8, and a spindle motor 10.

As shown in FIG. 2, the DSP 4 comprises a binarization circuit 4a, an EFM signal generation circuit 4b, a PLL circuit 4c, a signal processing circuit (jitter amount detector) 6, an error detection correction circuit (error rate amount detector) 7, and a servo circuit 9. The signal processing circuit 6 comprises a jitter detection circuit 6a, an amplifier 6b, and an A/D converter 6c.

As shown in FIGS. 1 and 2, when receiving a command signal CS from the microcomputer 8, the servo circuit 9 of the DSP 4 outputs control signals (focus balance signal FBAL, tracking balance signal TBAL, and motor control signal MTR) to the driver 5. Based on these control signals FBAL, TBAL, MTR, the driver 5 drives the optical pickup 2 and the spindle motor 10. As a result, the optical disc 1 rotates at given rotational speed, and in addition, the optical pickup 2 moves to the lead-in area of the optical disc 1. The optical pickup 2 irradiates the optical disc 1 with laser light and receives the reflected light to read out an RF signal (obtained from the reflected light). The RF amplifier 3 amplifies the RF signal read out by the optical pickup 2 and outputs the amplified signal to the DSP 4. According to the read-out RF signal, the servo circuit 9 of the DSP 4 generates the control signals so as to make the optical pickup 2 focus on the pit surface of the optical disc 1, and thereby establishes focusing servo and tracking servo.

The operation of the DSP 4 will be explained in detail below. As shown in FIG. 2, the RF signal is binarized by the binarization circuit 4a and then EFM-demodulated by the EFM signal generation circuit 4b. An EFM signal EFMO from the EFM signal generation circuit 4b is outputted to the jitter detection circuit 6a and the error detection correction circuit 7. The jitter detection circuit 6a detects a jitter (fluctuations of the digital signal in the time axial direction) amount from the EFM signal EFMO based on a PLL clock signal PLCK from the PLL circuit 4c and outputs it to the amplifier 6bThe amplifier 6b amplifies the output of the jitter detection circuit 6a and outputs it to the A/D converter 6c. The A/D converter 6c outputs a jitter amount JV as a digital signal to the microcomputer 8. Furthermore, the error detection correction circuit 7 performs an error detection correction process on the EFM signal EFMO and detects an error rate amount ER from the result.

Meanwhile, in the reproducing process, the DSP 4 performs processes such as EFM demodulation and error correction based on the binarized RF signal to obtain a digital audio signal and a digital video signal as reproduced signals.

Adjustment of Rotational Speed

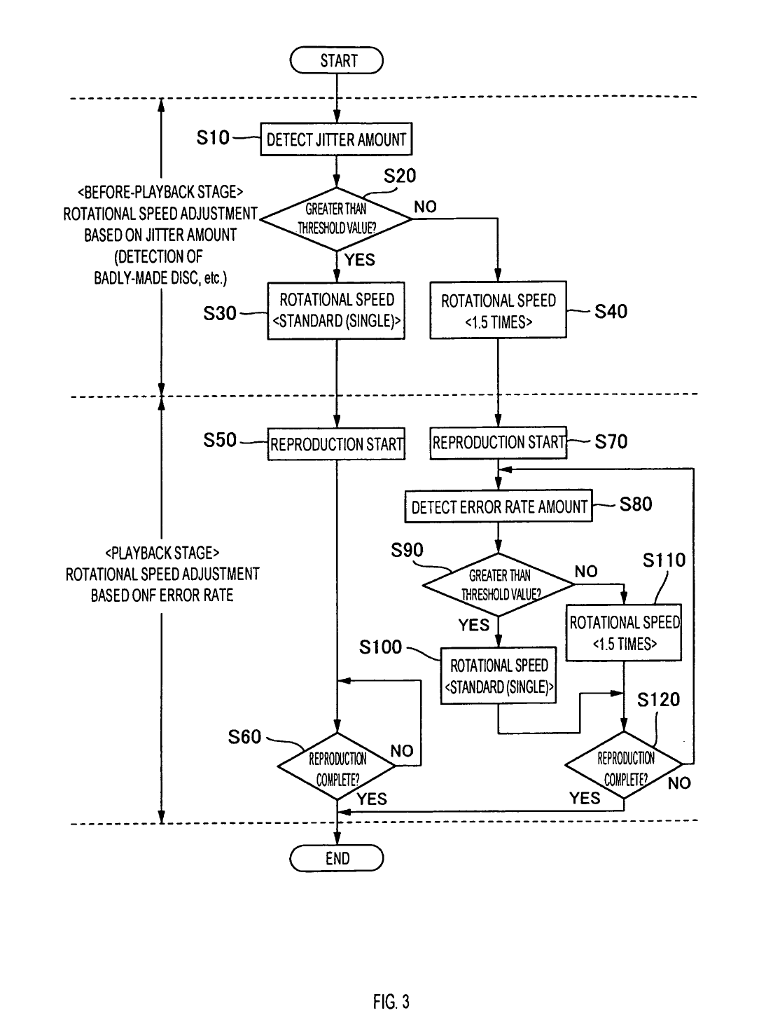

In the optical disc playback apparatus according to the present embodiment, the microcomputer 8 has a rotational speed adjustment function (hereinafter, simply called “rotation control” as needed) associated with the rotation of the optical disc by the spindle motor 10. This rotation control has two stages, initial automatic adjustment before playback of the optical disc and successive adjustment (real-time adjustment) during actual playback. That is, as shown in the flow chart of FIG. 3, at the stage before playback of the optical disc, rotation control is performed based on the jitter amount (S10 to S40), and at the optical disc playback stage, rotation control is performed based on the error rate amount (S50 and later).

First, the before-playback stage will be explained. Prior to playing the optical disc, as mentioned above, the jitter amount is detected (S10), and the microcomputer 8 determines whether the jitter amount is above a threshold value (S20). Note that data of the threshold value is stored beforehand as a reference table in a ROM of the microcomputer 8. If the jitter amount is above the threshold value (S20: YES), the rotational speed is set to single speed, a standard mode (standard speed defined in the standard for an optical disc such as DVD) (S30), and based on this setting, the microcomputer 8 sends the command signal to the servo circuit 9 in later actual playback.

Here, the jitter amount being above the threshold value means that the optical disc is determined to be of low quality or badly made and that high-speed rotation is not possible in terms of the improvement of playability. That is, the jitter amount being large to be above the threshold value means that fluctuations in the time axial direction of the obtained RF signal are so large that the RF signal cannot bear normal reproduction, and thus playability cannot be improved with current high-speed rotation.

Moreover, because a badly-made optical disc can be detected at the before-playback stage, an excess speed-adjustment operation after the start of playback can be reduced. That is, when an optical disc cannot be played at high rotational speed, the optical disc is played at the standard speed without the need for rotational speed adjustment during playback. Furthermore, based on the instantaneous jitter amount, the rotational speed of the optical disc can be adjusted instantaneously. This instantaneous adjustment is effective as before-playback adjustment, which is required to be a short time process.

On the other hand, if the jitter amount is not above the threshold value (S20: NO), the rotational speed is set to, for example, 1.5 times, a high speed mode (1.5 times the standard speed defined in the standard for an optical disc such as DVD) (S40), and based on this setting, the microcomputer 8 sends the command signal to the servo circuit 9 in later actual playback. That is, it means that even with making the optical disc rotate at high speed, the record signal can be sufficiently reproduced, thus being able to improve playability. That is, the jitter amount being small to be not above the threshold value means that fluctuations in the time axial direction of the obtained RF signal are not large so that the RF signal can bear normal reproduction, and thus playability can be improved with current high-speed rotation. Therefore, even if an optical disc has disturbances such as scratches, time during which the disturbances affect the reproduction in playback can be shortened due to the high speed rotation of the optical disc. For example, noise per block called block noise can be reduced. Thus, in playback, the influence of disturbances such as scratches on the servo system can be reduced.

Next, the playback stage will be explained. In the case where the optical disc is determined to be badly made at the above-mentioned before-playback stage and played at the standard-mode rotational speed, the rotational speed is maintained at the standard mode from the start of the reproducing process to the end of the reproducing process (S50 to S60) regardless of the error rate amount because the rotational speed cannot be increased.

On the other hand, in the case where at the above-mentioned before-playback stage the optical disc is determined to be able to be played at high rotational speed, the rotational speed is adjusted during playback based on the error rate amount detected at a predetermined sampling cycle. That is, for each region of the optical disc in which signals are recorded, the rotational speed is adjusted during playback based on the error rate amount. Specifically, when the reproducing process starts (S70), the error rate amount is detected (S80), and the microcomputer 8 determines whether the error rate amount is above a threshold value (S90). Note that data of the threshold value is stored beforehand as a reference table in the ROM of the microcomputer 8. If the error rate amount is above the threshold value (S90: YES), it is determined that the record signal cannot be reproduced sufficiently at rotational speed of 1.5 times, so that the rotational speed is lowered and set to single speed, the standard mode (S100), and based on this setting, the microcomputer 8 sends the command signal to the servo circuit 9. On the other hand, if the error rate amount is not above the threshold value (S90: NO), the rotational speed is maintained at 1.5 times, the high-speed mode (S110), and based on this setting, the microcomputer 8 sends the command signal to the servo circuit 9. Then, the process of S80 and later is repeated until the reproducing process finishes (S120: YES).

As described above, during playback, the error rate amount is detected at a predetermined sampling cycle, and the rotational speed of the optical disc is adjusted. Thus, the rotational speed can be adjusted to become an optimum speed according to the error rate amount as needed. In particular, corresponding to scratches and the like in each region such as the inner region and outer region of the optical disc, the rotational speed of the optical disc can be adjusted as needed.

Others

In rotating an optical disc, the optical disc need only be rotated at high speed. Hence, analog high-speed rotation control can also be performed, not being limited to multiplied speed. Here, the multiplied speed refers to high speed that the result of multiplying a positive, greater than one number of times the standard speed defined in the standard for an optical disc such as DVD, the number including not only integers but also real numbers other than integers such as 1.5 and 2.5. In terms of the degree of this high rotational speed, the rotational speed is preferably as high as possible within such a range that the record signal (pits) of the optical disc is readable. Thus, even if disturbances such as scratches exist on the optical disc, time during which the disturbances affect the reproduction in playback can be shortened due to the high-speed rotation of the optical disc. Therefore, in playback, the influence of disturbances such as scratches on the servo system can be reduced, and thereby playability can be improved.

In the case where the rotational speed of the optical disc is adjusted based on the jitter amount, the rotational speed of the optical disc can be appropriately adjusted so as to enable good reproduction. Moreover, the rotational speed of the optical disc can be instantaneously adjusted based on the instantaneous jitter amount.

In the case where the rotational speed of the optical disc is adjusted based on the error rate amount, the rotational speed of the optical disc can be appropriately adjusted so as to enable good reproduction.

Although the preferred embodiment of the present invention has been described in detail, it should be understood that various changes, substitutions and alterations can be made therein without departing from the spirit and scope of the invention as defined by the appended claims.

It is claimed:

1. An optical disc playback apparatus which makes an optical disc rotate at given rotational speed and reproduces a record signal based on light reflected from the optical disc, comprising:
a jitter amount detector that detects a jitter amount based on a signal obtained from said reflected light; and
a rotational speed adjustment circuit that adjusts said rotational speed of said optical disc based on said jitter amount.

2. The optical disc playback apparatus according to claim 1, wherein said rotational speed adjustment circuit performs said adjusting of said rotational speed prior to said reproducing from said optical disc.

3. The optical disc playback apparatus according to claim 1, wherein said rotational speed adjustment circuit adjusts said rotational speed to be multiplied speed when said jitter amount is equal or less than a threshold value.

4. The optical disc playback apparatus according to claim 2, wherein said rotational speed adjustment circuit adjusts said rotational speed to be multiplied speed when said jitter amount is equal or less than a threshold value.

5. An optical disc playback apparatus which makes an optical disc rotate at given rotational speed and reproduces a record signal based on light reflected from the optical disc, comprising:
an error rate amount detector that detects an error rate amount based on a signal obtained from said reflected light; and
a rotational speed adjustment circuit that adjusts said rotational speed of said optical disc based on said error rate amount.

6. The optical disc playback apparatus according to claim 5, wherein said rotational speed adjustment circuit performs said adjusting of said rotational speed during said reproducing from said optical disc.

7. The optical disc playback apparatus according to claim 5, wherein said rotational speed adjustment circuit adjusts said rotational speed to be multiplied speed when said error rate amount is equal or less than a threshold value.

8. The optical disc playback apparatus according to claim 6, wherein said rotational speed adjustment circuit adjusts said rotational speed to be multiplied speed when said error rate amount is equal or less than a threshold value.

9. An optical disc playback apparatus which makes an optical disc rotate at given rotational speed and reproduces a record signal based on light reflected from the optical disc, comprising:
a jitter amount detection circuit that detects a jitter amount based on a signal obtained from said reflected light;
a first rotational speed adjustment circuit that adjusts said rotational speed of said optical disc based on said jitter amount;
an error rate amount detector that detects an error rate amount based on a signal obtained from said reflected light; and
a second rotational speed adjustment circuit that adjusts said rotational speed of said optical disc based on said error rate amount.

10. A microcomputer used in an optical disc playback apparatus according to any one of claims 1 through 8, which functions at least as said rotational speed adjustment circuit.

11. A microcomputer used in an optical disc playback apparatus according to claim 9, which functions at least as said first and second rotational speed adjustment circuits.

12. A rotational speed control method for an optical disc playback apparatus which makes an optical disc rotate at given rotational speed and reproduces a record signal based on light reflected from the optical disc, said method comprising the steps of:
detecting a jitter amount based on a signal obtained from said reflected light; and
adjusting said rotational speed of said optical disc based on said jitter amount.

13. A rotational speed control method for an optical disc playback apparatus which makes an optical disc rotate at given rotational speed and reproduces a record signal based on light reflected from the optical disc, said method comprising the steps of:
detecting an error rate amount based on a signal obtained from said reflected light; and
adjusting said rotational speed of said optical disc based on said error rate amount.

14. A rotational speed control method for an optical disc playback apparatus which makes an optical disc rotate at given rotational speed and reproduces a record signal based on light reflected from the optical disc, said method comprising the steps of:
detecting a jitter amount based on a signal obtained from said reflected light;
adjusting said rotational speed of said optical disc based on said jitter amount;
detecting an error rate amount based on a signal obtained from said reflected light; and
adjusting said rotational speed of said optical disc based on said error rate amount.
